(19) United States
(12) Patent Application Publication
(10) Pub. No.: US 2010/0171591 A1
(43) Pub. Date: Jul. 8, 2010

(54) SYSTEM COMPRISING A TRANSPONDER, CONSUMER ITEM OR OTHER PRODUCT, AND METHOD FOR FITTING AN ITEM WITH A TRANSPONDER

(76) Inventors: Inge Ritzka, Eschweiler (DE); Nikolaus Vogels, Aachen (DE)

Correspondence Address: COLLARD & ROE, P.C., 1077 NORTHERN BOULEVARD, ROSLYN, NY, 11576, US

(21) Appl. No.: 12/449,858

(22) PCT Filed: Feb. 28, 2008
(86) PCT No.: PCT/DE2008/000351

§ 371 Date: Dec. 21, 2009

Related U.S. Application Data
(60) Provisional application No. 60/904,332, filed on Mar. 1, 2007.

(30) Foreign Application Priority Data
Mar. 1, 2007 (DE) 10 2007 010 400.8

(51) Int. Cl. H04Q 5/22

(52) U.S. Cl. 340/10.1

(57) ABSTRACT

The aim of the invention is to improve previously known systems and applications for protecting persons and goods. The aim is achieved by a method for protecting persons and goods and structurally delimiting closed areas by means of a transponder, e.g. an RFID chip, which is permanently or removably mounted on an item or a person and allows data on the item and the persons' status to be stored, means for recognizing the transponder and the transponder data that is stored using the transponder, means for storing reference data on the transponder data, and a central administration for comparing the transponder data and the reference data.

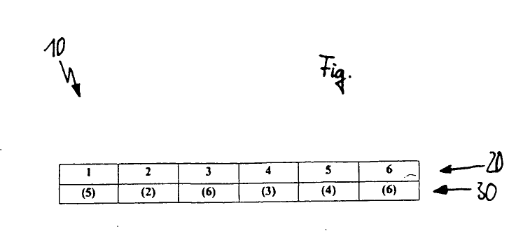

The invention relates to a system comprising a transponder on the one hand, such as an RFID chip, which is arranged on the item or person and by means of which data on the item or the status of the person is storable as transponder data, means for detecting the transponder and the transponder data stored by means of the transponder, means for storing reference data with regard to the transponder data and a central administration for comparing the transponder data and the reference data.

The system is suitable, above all, for the protection of persons and items or for verifying the status of ownership and/or authenticity of the item. The transponder is preferably permanently and non-detachably arranged on the item or a person.

In addition the invention is intended for the detection of items in order to unequivocally allocate ownerships, whereby the items are connected, in particular permanently and non-detachably, to a transponder.

In addition the invention relates to a consumer item or other product which is connected, in particular permanently and non-detachably, to the transponder, whereby the transponder has a first data field for storing data on the item and a second data field for storing manufacturing data.

The invention further relates to a method for marking items where an item is equipped, in particular permanently and non-detachably, with a transponder, and where data on the manufacturer and on the item is stored as transponder data directly on the item by means of the transponder.

Generic methods are known from the prior art, where valuable goods, in particular, are equipped with a transponder such as an RFID chip or an IC label. In particular, such transponders are arranged on goods in order to ensure that these goods are protected against theft. An alarm is triggered as soon as a transponder arranged on an item gets into the vicinity of a corresponding detection unit.

In addition a control module for products is known from the laid-open specification DE 10 2004 032 331 A1, which is arranged in or on the product to be controlled. The product is provided with unequivocal product identification by means of the control module, and the control module is connectable, in a structurally simple way, to an external read/write unit by means of wireless communication. By means of control modules integrated in this way the products equipped with them are protected especially effectively against theft, since an illegal owner of a product reported as stolen always has to reckon with the fact that, without noticing it, he might get into the vicinity of an external read/write unit and thus initiate a corresponding signal which reveals the location of the stolen product.

Also a consumer goods administration system is known from the laid-open specification DE10 2004 046 399 A1, where a consumer item is equipped with an IC label on which, apart from direct consumer goods data, further administration data is stored such as data relating to the point in time of the purchase/sale of the consumer item between two persons.

Apart from the IC label which is arranged directly on the consumer item, the consumer goods administration system additionally comprises an administration card accompanying the consumer item which is passed from one owner to a new owner and which also stores administration data on the consumer item.

For example, a buyer can check, using the administration data, whether the alleged owner of the consumer item is stored not only on the IC label but also on the administration card. To this end, the consumer goods administration system compares the administration data on the IC label with the administration data on the administration card. This will ensure that the owner of the consumer item is indeed the true owner of the consumer item.

The consumer goods administration system thus offers good gapless ownership tracking from the point in time when the consumer item was first purchased to the point in time when the consumer item is disposed of.

It is the requirement of the present invention to further develop known marking systems for consumer goods and persons and to simplify their handling for the user.

The requirement of the invention is met, on the one hand, by a generic system comprising a transponder, such an RFID chip, where the central administration comprises means for storing reference data.

Advantageously, data regarding the present item and/or ownership of the item, for example, is stored not only on a transponder which is permanently and non-detachably connected to the item, but there exists a “copy of the data” as a reflection in form of reference data in the central administration.

Herein lies the decisive difference between the present invention and known systems, since these systems perform an identification either only by means of a transponder attached to an item or because these systems store reference data de-centrally, such as in an administration card, which is not administered by a neutral third person.

With the invention, however, reference data are hosted centrally by a neutral service provider, so that any manipulation for the reference data is excluded.

Advantageously, therefore, it is possible to check whether the transponder data matches the reference data as soon as the transponder gets into the vicinity of corresponding detecting means and the transponder data is read from the transponder by means of detecting means. If the transponder data on the transponder do not match the corresponding reference data in the central administration, there is the strongest probability that the item was stolen or pirated. In particular in the case of piracy, there would not exist any or at least only faulty reference data on the corresponding item in central administration because at least corresponding manufacturing data would be missing which the manufacturer, for example, passes on to central administration with his respective authentication and which is stored there under reference data.

In terms of this invention, RFID chips (radio frequency identity) are extremely suitable for use in the verification system described in here, due to their capability to send, receive and store data without touch or visual contact. It is, however, understood that other transponders with similar properties may be used as well. This allows goods equipped with transponders to be quickly and preferably automatically traced and identified.

The possibility of permanently tracing goods and additionally the possibility of automatically matching transponder data to reference data, in particular, permits recording the transfer of ownership from a seller to a buyer, detecting cases of piracy and thus protection against unlicensed reproductions, detecting stolen goods due to capturing corresponding data in central administration for worldwide registration.

Advantageously any person or company can participate in this verification system which has his/her/their goods equipped with transponders registered accordingly at the central administration. It is therefore advantageous if the central administration comprises means for storing registered transponders.

The paraphrase that the transponder can be arranged permanently and non-detachably on the item or a person also includes the capability that the transponder may be detachably attached to the respective item. Depending upon the field of application it is advantageous if the transponder can also be detached again from the item.

A preferred variant of the embodiment provides for the central administration comprising means for associating a credit card identification with a transponder. Advantageously there is a particularly simple way of realizing the verification system according to the invention if the verification system is implemented in an existing payment system, for example on the basis of electronic cash. Such payment systems already have a close-knit distribution network and their operators are experienced in the handling and administration of correspondingly large amounts of data.

In this context it is advantageous if the central administration comprises means for calculating and associating administration fees. It is therefore possible that a service provider such as a credit card company who would implement the present verification system in its periphery, could advantageously register and process services in connection with the verification system.

The detection means may be arranged centrally. In order to be able to use the system for verifying ownerships and/or for verifying an authenticity comprehensively and covering a whole area, it is advantageous if the detection means are arranged de-centrally and preferably globally. For example, corresponding detection means are envisaged in specialist shops, department stores, banks and/or at the manufacturer. Public access via the internet is also possible, thereby enabling verification of an item also in the private field. Advantageously the detection means are able not only to read data from a transponder but also to send data to a transponder and write data to the transponder preferably permanently.

In particular in connection with protection against theft it is of advantage if the detection means are arranged such that they delimit closed areas. In this way salesrooms, for example, can be structurally relatively easily delimited in a burglar-proof manner.

The invention also relates to an unequivocal detection of dangerous or protected areas, whereby persons or goods can be unequivocally allocated and the areas can be blocked, unblocked or monitored for these persons or goods. These persons or goods would be equipped for detection with a transponder, which can be permanently and non-detachably or detachably attached to the persons or goods by means of a tag or bracelet.

A special characteristic of the invention is the detection of dangerous or protected areas, whereby the protection of persons, in particular children, mentally handicapped or old persons come to the fore. The invention provides for areas destined as a protected zone to be provided with a special status which includes the possibility of blocking the respective areas, transmitting warning signals when these areas are entered into or monitoring the detected persons with regard to their safety.

In particular in connection with the protection of critical sensitive areas (e.g. airports) it is advantageous, if the detection means are arranged such that they delimit closed areas. Thus baggage zones, for example, can be structurally delimited relatively easily and prevent the unauthorised intrusion of inadmissible pieces of baggage during storing and loading for air traffic.

Further, the invention includes a protection and detection system, which can make the personal and primary data of persons injured in an accident available to rescue personnel at the place of accident. For detection the persons are equipped with a transponder which is permanently and non-detachably or detachably attached to the persons by means of a tag or bracelet.

A further application possibility of the invention is the secure monitoring of packet and letter consignments for safety-relevant areas. These packet and letter consignments would be equipped with specially manufactured transponders which ensure unequivocal detection and association of the sender. Packet and letter consignments without this detection characteristic are forwarded to the consignee only after a previously carried-out check. For detection all packet and letter consignments for the protected consignee area are passed through a lock with an appropriate reading system.

The system of the invention allows a particularly precise verification of an item or a person to be carried out, if the transponder comprises data regarding an identification of a manufacturer and/or in particular data regarding an identification of the item and/or in particular data regarding a production number and/or in particular data regarding an identification of a wholesaler and/or intermediary and/or in particular data regarding an identification of a retailer and/or sales outlet and/or in particular data regarding an identification of a buyer and/or an owner and/or in particular data regarding an identification status of the item.

It is of advantage if the transponder unequivocally allocates and centrally records or matches data to the ownership of an item. The transponder can detect data regarding a dangerous or protected area, centrally administrate it and unblock, block or monitor areas corresponding to the specified status. According to one embodiment the transponder can record data regarding a sensitive area, match data with central administration and automatically actuate regulations specified for the sensitive area.

In another field of application injured persons equipped with the transponder are recorded and their personal and primary data immediately read out on a reading device from a centrally administered administration. Apart from personal data (name, age, place of residence etc.) medically important data (blood group, status of sickness, allergies etc.) can be recorded in the administration of personal and primary data.

Furthermore it is of advantage if the transponder comprises data regarding the identification status of the item or persons, which is required for the safety-relevant monitoring of packet and letter consignments.

The above-mentioned data can all be stored cumulatively or merely partially in a transponder. This can be made dependent, for example, on the kind of monitoring and/or the kind of value of the item. In this way the expenditure regarding an item monitored by the verification system can be adapted to suit the needs and wishes of a customer.

In this context the requirement of the invention is also met by a consumer item or other product which is permanently and non-detachably connected with a transponder, and the transponder comprises a first data field for storing data on the item and a second data field for storing manufacturing data and the transponder comprises at least one further data field for storing dealer data.

Advantageously the origin of a consumer item can be determined using existing dealer data. This at least allows first conclusions to be drawn regarding the authenticity of a consumer item, since authenticity can almost certainly be assumed if the consumer item was purchased or acquired from an authorized dealer.

It is of advantage if the transponder comprises a data field for storing distributing data. If the transponder cumulatively or alternatively contains distribution data, not only its origin but also individual dealer stations can be tracked back.

In addition it is advantageous if the transponder comprises a data field for storing consumer data. In this way too, it is possible to check the authenticity of a consumer item because previous owners can be registered by means of consumer data.

It is especially advantageous if the transponder comprises a data field for storing transfer of ownership data. In this way, above all, it can be determined whether an item was stolen or whether there was a rightful change of owner.

The requirement of the invention is also met by a method for marking goods, where an item is permanently and non-detachably connected with a transponder and manufacturing data and goods data is stored directly on the item as transponder data, and where additionally dealer data on the dealer, such as a wholesaler, an intermediary and/or a retailer is stored directly on the item by means of the transponder.

Besides it is advantageous if the dealer data is transmitted by the manufacturer to the transponder and stored on the item by means of the transponder. In particular, it is in the interests of the manufacturer if his goods are protected, in particular, against piracy. If a manufacturer already enters dealer data into the transponder relating to the names of dealers to which their goods were passed on or sold, a first step for recording an item has already been taken.

A further enhancement in security is ensured, if distribution channel data such as sales outlets are stored directly on the item by means of the transponder.

In this context a further advantageous if consumer data are stored directly on the item by means of the transponder. In this way also an enhancement in security is ensured.

In particular, if there is a change of ownership from one consumer to the next, it is advantageous if transfer of ownership data are stored directly on the item by means of the transponder.

So as to simplify the method according to the invention as much as possible, it is advantageous if a status such as a status of ownership of an item is ascertained exclusively by means of the transponder data. In order to be able to carry out a first check regarding the ownership or the authenticity of an item structurally quickly and simply, it is sufficient if dealer data, distribution channel data, consumer data and/or transfer of ownership data is additionally stored on the transponder of the item. In particular for items which are not of very high value, this could already be sufficient to secure a deal. Cumulatively, however, in a second step, use could be made of the service to compare the transponder data with corresponding reference data at a central administration, for example then, when the intention to purchase appears to be serious. This comparison could be subject to costs.

In order to make it easy to check the transponder data for manipulation, it is advantageous if the transponder data are transmitted to a central administration and are held there as reference data ready to be called off. Advantageously, if data in the transponder data has been changed and/or amended, a transponder match is carried out against reference data of a central administration. By way of these reference data it is ensured that the transponder data have not been manipulated.

An advantageous further development of the method provides for a difference between transponder data and reference data to be signaled to a suitable output means. In this way it is ensured that possible manipulations of a consumer item, in particular of a transponder, are indicated quickly and reliably to a user of the method or the present verification system

Besides it is advantageous if reference data of a transponder are amended with data on a loss status of a stolen item. If the reference data contain corresponding details, it is ensured that a match of the transponder data against the reference data immediately indicates that something is wrong with the present consumer item and that a more detailed check would be indicated.

It is advantageous if transponder data of an item is ascertained by means of de-centrally arranged detection means, transmitted to a central administration and the transmitted transponder data is compared to the respective reference data.

In particular with regard to protection against theft it is advantageous if a seller of an item authenticates the sale of the item with an identification allocated to the seller, if corresponding data of the sale and of the authentication is stored in the transponder attached to the item and the corresponding data is transmitted to a central administration and stored there as reference data.

Accordingly it is advantageous if a buyer of an item authenticates the purchase of the item with an identification allocated to the buyer, if corresponding data of the purchase and the authentication is stored in the transponder attached to the item and the corresponding data is transmitted to a central administration and stored there as reference data.

It is especially advantageous if an alteration and/or amendment of an owner identification is not performed until after the identification code of a seller and/or buyer has been entered. This means that two parties always must authenticate a change of ownership.

A preferred variant of the embodiment provides that the seller and/or buyer of an item authenticate themselves by means of a credit card. Credit card systems provide a low-cost possibility of carrying out an exact identification of a person because corresponding credit card networks already exist worldwide.

A further development of the invention provides for a dialog field for different services to be called up at a suitable output means by means of data of a transponder data field such as a credit card number. In this way services can be made available to a user, for example against payment of a fee. It is thus possible, for instance in a mode called “safe function”, to read image data relating to other valuable possession by means of a scanner and to store these at the central administration. These image data can then be called up as needed and indicated on the output means.

Further advantages, objectives and characteristics of the present invention will now be explained by way of the description of the attached drawing in which a typical layout of an RFID chip is illustrated.

In the single FIGURE a layout of an RFID chip with a 26-digit identification is schematically shown.

The allocation table 10 of an RFID chip of a verification system shown in the single FIGURE has a total of six data fields 1, 2, 3, 4, 5 and 6 in a first table row 20.

In the allocation table 10 data comprised of 5 digits is held on a manufacturer in field 1, data comprised of 2 digits on a product is held in field 2, data comprised of six digits on a serial number of the production is held in field 3, data comprised of 3 digits on a first buyer, such as a dealer, is held in field 4, data comprised of four digits on a sales outlet is held in field 5, and data comprised of six digits on an end customer is held in field 6.

The data comprised of several digits is written to a second table row 30. Thus in a first column field 1 holds a 5-digit manufacturer identification of a manufacturer, whereby each manufacturer connected to the verification system has been allocated his personal manufacturer-ID. In a second column comprising field 2, every manufacturer can allocate an appropriate product-ID to his product. In a third column comprising field 3 a 6-digit ID is allocated to the serial number of the production. In a fourth column comprising field 4 a 3-digit buyer-ID has been recorded, in a fifth column comprising field 5 a sales outlet or a seller has been assigned a 4-digit ID and in a sixth column comprising field 6 an end customer has been assigned a 6-digit owner-ID.

Thus the allocation table 10 not only comprises data on the manufacturer, the product and the serial number of the production, but in addition also data on the dealer, the sales outlet and the end customer. In this way a very effective way of protecting a consumer item against theft is realized.

No detailed explanation of the technology of the RFID chips is given here since this is sufficiently known from the prior art. It is understood that instead of the RFID chip described other transponders can be employed provided these have readable and writable fields.

In order to make an unlicensed reproduction of a high-value consumer item unattractive a manufacturer-typical identification for the respective product has been recorded on the consumer item by means of the RFID chip. In case of the sale of the consumer item to a dealer the dealer can check the authenticity of the consumer item by means of the present verification system and, as necessary, enter his status of ownership at the same time via the verification system. Thus, by performing such a match, it can be checked whether the item is authentic, whether the production data match, whether the new ownership has been registered in the verification system and in the RFID chip. The ownership status registered in the verification system remains in place until the ownership rights, through a sale or similar transaction, are transferred to a new owner. The transfer of ownership may be legitimized using personal identification codes.

A buyer can protect himself against piracy in that he buys a consumer item from a seller such as a dealer authorized in the verification system. During the purchase data is entered into the verification system, for example data on the consumer item as such, on the RFID chip, on an identification code of the seller and on an identification code of the buyer. The identification codes may, for example, be realized by means of a cash guarantee card number. Due to corresponding confirmations by the seller and the buyer in the verification system ownership is transferred to the buyer. A corresponding proof may be printed out on a printer, as necessary. The advantages of the described verification system are, among others, that due to checking the data in the verification system the buyer is protected against fakes, that the transfer of ownership and the current status of ownership are registered in a central system, that a customer can mark a consumer item as stolen in the verification system.

In particular, the identification of theft in a worldwide functioning system offers high protection for consumers because consumer items identified as stolen goods are practically unsaleable. Advantageously every consumer participating in the verification system can call off information on a consumer item offered to him and registered.

It is understood that the application cases described above are only a selection of possible uses and that these application cases, as regards the present invention, are understood to be non-limiting.

There may, for instance, be application cases, where it is advantageous if the configuration of the data fields of the above-described allocation table is not already firmly fixed, but can be variable and thus individually adapted. For example field 1 could receive and offer data comprising 3 digits or 7 digits instead of 5 digits.

1. A system comprising a transponder, such as an RFID chip, which is arranged on the item or a person and by means of which data on the item or the status of the person are storable as transponder data, means for detecting the transponder and transponder data stored by means of the transponder, means for storing reference data with regard to the transponder data, and a central administration for comparing the transponder data and the reference data,
wherein the central administration comprises means for storing the reference data.

2. System according to claim 1, wherein the central administration comprises means for storing registered transponders.

3. System according to claim 1, wherein the central administration comprises means for associating a credit card ID with a transponder.

4. System according to claim 1, wherein the central administration comprises means for calculating and associating administration fees.

5. System according to claim 1, wherein the detection means are arranged de-centrally and preferably globally.

6. System according to claim 1, wherein the detection means are arranged in such a way that they delimit closed areas.

7. System according to claim 1, wherein the transponder comprises data on an identification of a manufacturer.

8. System according to claim 1, wherein the transponder comprises data on an identification of the item or of persons.

9. System according to claim 1, wherein the transponder comprises data on a production number of the item.

10. System according to claim 1, wherein the transponder comprises data on an identification of a wholesaler and/or intermediary.

11. System according to claim 1, wherein the transponder comprises data on an identification of a retailer and/or a sales outlet.

12. System according to claim 1, wherein the transponder comprises data on an identification of a seller and/or an owner.

13. System according to claim 1, wherein the transponder is permanently and non-detachably arranged on the item or a person.

14. System according to claim 1, wherein the transponder unequivocally allocates and centrally records/matches data on the status of ownership of an item.

15. System according to claim 1, wherein the transponder detects data on a dangerous or protected area, centrally administers them and unblocks, blocks or monitors areas corresponding to the specified status.

16. System according to claim 1, wherein the transponder records data on a sensitive area, matches data with the central administration and automatically actuates the regulations specified for the sensitive area.

17. System according to claim 1, wherein injured persons are recorded with the transponder, and wherein personal and primary data is read out of a centrally administered administration on a reading device.

18. System according to claim 1, wherein the transponder comprises data on an identification status of the item or persons, which identification status is necessary for the safety-relevant monitoring of packet and letter consignments.

19. System according to claim 1, wherein the transponder comprises data on an identification status of the item or person.

20. A consumer item or other product which is connected, in particular permanently and non-detachably, with a transponder, and the transponder comprises a first data field for storing data on the item and a second data field for storing data on the manufacturer,
wherein the transponder comprises at least one further data field for storing dealer data.

21. A transponder according to claim 14, wherein the transponder comprises a data field for storing distribution data.

22. Transponder according to claim 14, wherein the transponder comprises a data field for storing consumer data.

23. Transponder according to claim 14, wherein the transponder comprises a data field for storing transfer of ownership data.

24. A method for marking goods, where an item is equipped with a transponder, in particular permanently and non-detachably, and where data of the manufacturer and of the item is stored directly on the item as transponder data,
wherein dealer data of a dealer such as a wholesaler, an intermediary or a retailer is stored directly on the item by means of the transponder.

25. Method according to claim 18, wherein the dealer data is transmitted from the manufacturer to the transponder and is stored on the item by means of the transponder.

26. Method according to claim 18, wherein distribution channel data such as sales outlets is stored directly on the item by means of the transponder.

27. Method according to claim 18, wherein consumer data is stored directly on the item by means of the transponder.

28. Method according to claim 18, wherein transfer of ownership data is stored directly on the item by means of the transponder.

29. Method according to claim 18, wherein a status such as a status of ownership of an item is ascertained exclusively by means of the transponder data.

30. Method according to claim 18, wherein transponder data is transmitted to a central administration and is held there as reference data ready to be called-off.

31. Method according to claim 24, wherein the reference data is stored and administered by means of the central administration.

32. Method according to claim 24, wherein a difference between transponder data and reference data is signaled to a suitable output means.

33. Method according to claim 24, wherein the reference data of a transponder is amended by data of a loss status of a stolen item.

34. Method according to claim 24, wherein the transponder data of an item is ascertained by means of de-centrally arranged detection means, transmitted to a central administration and wherein the transmitted transponder data is matched to corresponding reference data of the item.

35. Method according to claim 24, wherein for an alteration of data and/or an amendment of data of the transponder data a transponder match is carried against reference data of a central administration.

36. Method according to claim 18, wherein a seller of an item authenticates the sale of the item with a seller-ID allocated to the seller, wherein corresponding data of the sale and authentication of the transponder attached to the item is stored and wherein the corresponding data is transmitted to a central administration and stored there as reference data.

37. Method according to claim 18, wherein a buyer of an item authenticates the purchase of the item with a buyer-ID allocated to the buyer, wherein corresponding data of the purchase and authentication is stored in the transponder attached to the item and wherein the corresponding data is transmitted to a central administration and stored there as reference data.

38. Method according to claim 18, wherein an alteration and/or amendment of an owner-ID is not carried out until a seller's identification code has been entered.

39. Method according to claim 18, wherein an alteration and/or amendment of an owner-ID is not carried out until a buyer's identification code has been entered.

40. Method according to claim 18, wherein sellers and/or buyers of an item authenticate themselves by means of a credit card.

41. Method according to claim 18, wherein a dialog field for different services is called up at a suitable output means by means of data of a transponder data field such as a credit card number.
